(19) United States
(12) Patent Application Publication
(10) Pub. No.: US 2012/0251848 A1
(43) Pub. Date: Oct. 4, 2012

(54) Rechargeable battery pack

(75) Inventor: Su-Sang Cho, Yongin-si (KR)

(73) Assignee: Samsung SDI Co., Ltd., Yongin-si (KR)

(21) Appl. No.: 13/200,386

(22) Filed: Sep. 23, 2011

(30) Foreign Application Priority Data
Mar. 31, 2011 (KR) 10-2011-0029517

(51) Int. Cl. H01M 2/10; H01M 10/42; H01M 2/12

(52) U.S. Cl. 429/7; 429/159; 429/83

(57) ABSTRACT

A rechargeable battery pack for improving watertight performance for unit cells and a protection circuit module by draining water having permeated into a case while allowing inflow and outflow of cooling air into/out of the case. The rechargeable battery pack includes at least one unit cell including a rechargeable battery, and a case for supporting the unit cell and receiving the same, wherein the case includes a bottom, a reinforcing rib protruded in the bottom, and a drainage hole formed in the bottom beneath the reinforcing rib.

### CLAIM OF PRIORITY

This application makes reference to, incorporates the same herein, and claims all benefits accruing under 35 U.S.C. §119 from an application earlier filed in the Korean Intellectual Property Office on the 31 of Mar. 2011 and there duly assigned Serial No. 10-2011-0029517.

### BACKGROUND OF THE INVENTION

1. Field of the Invention

The described technology relates generally to a rechargeable battery pack with improved watertight performance and a unit cell protecting function.

2. Description of the Related Art

A rechargeable battery can be used as a unit cell, or unit cells can be used by electrically connecting them with each other depending on the types of devices. For example, a rechargeable battery pack includes a plurality of unit cells, a protection circuit module (PCM) for protecting the unit cells, and a case for electrically connecting the unit cells and the protection circuit module and embedding them in the case.

For example, the case includes an air hole at a position that is higher than the lowest position of the bottom so as to control outer air to inflow into the unit cells and cool the unit cells.

The rechargeable battery pack with the case is applicable to portable machine tools. In this case, rainwater may enter the case through the air hole when it rains.

The air hole is formed at a high position from the bottom of the case, so water having permeated through the air hole does not come out of the air hole but remains in the case. The water collected inside the case enters the gaps between the unit cells and it also enters the protection circuit module depending on how the rechargeable battery pack is provided, and it generates an electrical short so that the rechargeable battery pack may be seriously damaged and may not be used any longer.

The above information disclosed in this Background section is only for enhancement of understanding of the background of the described technology and therefore it may contain information that does not form the prior art that is already known in this country to a person of ordinary skill in the art.

### SUMMARY OF THE INVENTION

The described technology has been made in an effort to provide a rechargeable battery pack for improving watertight performance for unit cells and a protection circuit module by discharging water having permeated into a case while allowing inflow and outflow of cooling air into/out of the case.

The present invention has been made in another effort to provide a rechargeable battery pack for improving a protection function for the unit cells by preventing permeation of a foreign substance while discharging the permeated water.

An exemplary embodiment provides a rechargeable battery pack that includes: at least one unit cell including a rechargeable battery; and a case for supporting the unit cell and receiving the same, wherein the case includes a bottom, a reinforcing rib protruded in the bottom, and a drainage hole formed in the bottom corresponding to the reinforcing rib.

The case further includes a supporter formed in the bottom corresponding to a side part of the unit cell so as to support the side part of the unit cell.

The rechargeable battery pack further includes a ventilating sheet provided between the supporter and the unit cell.

The rechargeable battery pack further includes an insulating sheet provided between the supporter and the unit cell.

The rechargeable battery pack further includes a buffering sheet provided between the supporter and the unit cell.

The drainage hole is further extended in the bottom of the reinforcing rib.

The reinforcing rib has a height and a width that are set in the bottom, and forms a groove connected to the drainage hole to be disposed in the drainage hole.

The drainage hole is formed to have a circular cylinder shape extending from the inside of the bottom to the outside thereof.

The drainage hole is formed to have a truncated circular cone shape extending from the inside of the bottom to the outside thereof.

The bottom has a gradient so that a part where the drainage hole is formed is low.

The drainage hole is formed in an outer portion of the bottom, and the bottom is formed to have a high center and a low outer portion.

The drainage hole is formed in the outer portion of the bottom, and the bottom is formed to have a thick center and a thin outer portion.

According to the embodiment, a drainage hole is formed at a part where a reinforcing rib is positioned on the bottom of the case so the inflow and outflow of the cooling air is allowed and the water having permeated into the case is discharged. Therefore, watertight performance for the unit cells and the protection circuit module is improved. In addition, according to the exemplary embodiment, the reinforcing rib is provided in the drainage hole so the permeated water is discharged to the drainage hole and permeation of alien substance is prevented. Accordingly, the unit cell protecting function is improved.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 shows a perspective view of a rechargeable battery pack according to a first exemplary embodiment;

FIG. 2 shows a top plan view of a lower case shown in FIG. 1;

FIG. 3 shows a cross-sectional view with respect to a line shown in FIG. 2;

FIG. 4 shows a cross-sectional view with respect to a line IV-IV shown in FIG. 2;

FIG. 5 shows a partial cutaway perspective view of a drainage hole shown in FIG. 4;

FIG. 6 shows a partial cross-sectional view of a rechargeable battery pack according to a second exemplary embodiment;

FIG. 7 shows a cross-sectional view of a rechargeable battery pack according to a third exemplary embodiment; and

FIG. 8 shows a cross-sectional view of a rechargeable battery pack according to a fourth exemplary embodiment.

### DETAILED DESCRIPTION OF THE INVENTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. The drawings and description are to be regarded as illustrative in nature and not restrictive. Like reference numerals designate like elements throughout the specification.

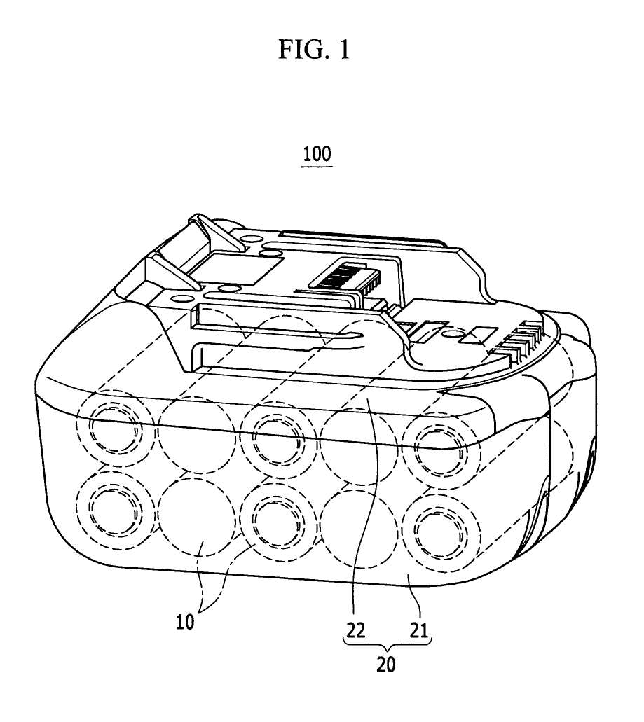

FIG. 1 shows a perspective view of a rechargeable battery pack 100 according to a first exemplary embodiment. Referring to FIG. 1, the rechargeable battery pack 100 includes unit cells 10 configured as a rechargeable battery, and a case 20 for receiving the unit cells 10 and supporting the same.

For example, the unit cells 10 can be formed to be a cylindrical rechargeable battery for repeatedly performing charging and discharging operations. That is, the unit cell includes an electrode assembly formed by providing a separator and stacking/spirally winding a positive electrode and a negative electrode, a can containing an electrolyte solution and an electrode assembly, and a cap assembly (not shown) provided to the can in an airtight structure.

The case 20 sets the number of unit cells 10 to be received, and it is formed to receive the unit cells 10 in a limited space in an optimized manner. For example, the case 20 includes a lower case 21 for receiving the unit cells 10 and supporting the same, and an upper to case 22 for receiving the protection circuit module (not shown) electrically connected to the unit cells 10 to be combined with the lower case 21.

The rechargeable battery pack 100 according to the first exemplary embodiment can be used for a power tool that is frequently used in the field. Therefore, the case 20 requires excellent watertight characteristic, and it also needs an excellent cooling characteristic for the built-in unit cells 10.

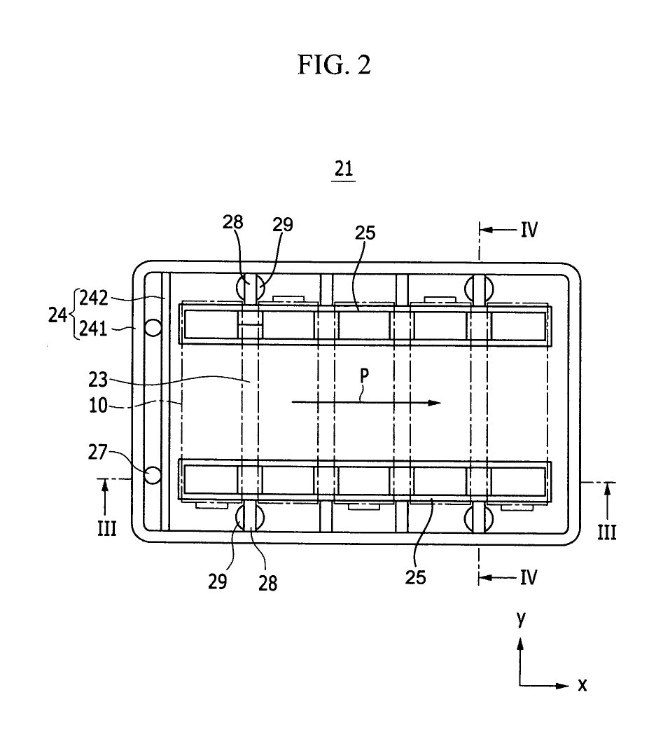

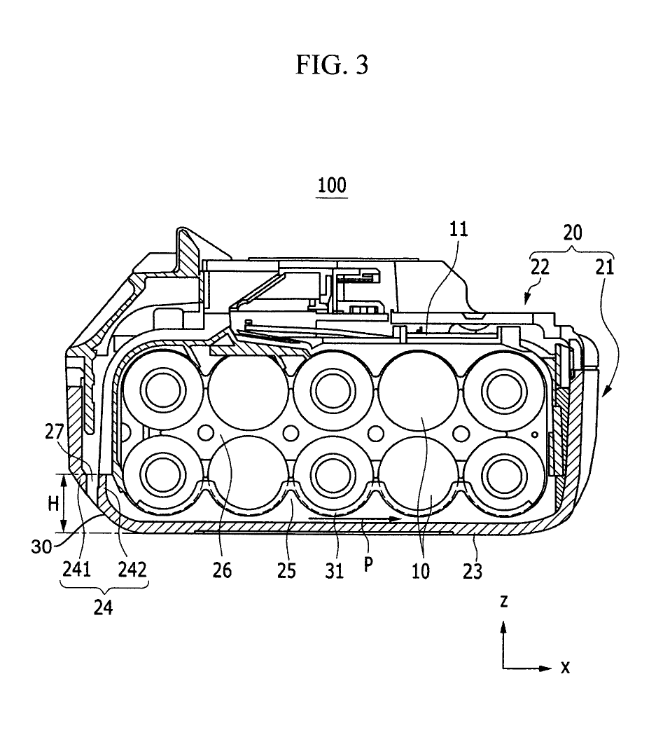

FIG. 2 shows a top plan view of a lower case 21 shown in FIG. 1, and FIG. 3 shows a cross-sectional view with respect to a line III-III shown in FIG. 2. Referring to FIG. 2 and FIG. 3, the lower case 21 includes a bottom 23 for forming a space for receiving the unit cells 10, a side wall 24 formed to surround an outer portion of the bottom 23, and a supporter 25 formed on the bottom 23 corresponding to a side part of the unit cell 10 to support the side part of the unit cell 10.

For example, in the case of receiving five unit cells 10, the bottom 23 includes five pairs of supporters 25 for supporting the five unit cells 10. Also, the side wall 24 includes a spacer 26 and is formed to surround the side of the unit cells 10 that are stacked in two layers. The number of the unit cells 10 supported by the bottom 23 and the number of layers of the unit cells 10 stacked on the bottom 23 are set in various ways according to the required outputs.

The unit cells 10 are electrically connected to a protection circuit module 11 in series or in parallel by a connecting member (not shown). The protective circuit module 11 forms a protective circuit on a printed circuit board to protect the unit cells 10 from an overcharge, overdischarge, overcurrent, and short circuit.

The supporter 25 include curved concave grooves so as to stably support unit cells 10 that are formed as cylindrical rechargeable batteries. Further, the supporter 25 is formed on both sides (in the y-axis direction shown in FIG. 2) of the bottom 23 so as to support both ends of each unit cell 10.

Therefore, an air flow path (P) is formed in the x-axis direction between each supporter 25 on both sides and between the unit cells 10 and the bottom 23. The cooling air is supplied to the bottom part of the unit cell 10 and between the unit cells 10 through the air flow path (P) to prevent overheating of the unit cells 10.

For this purpose, the lower case 21 includes an air hole 27 on a radial part 30 where the bottom 23 is connected to the side wall 24. The air hole 27 is formed (in the z-axis direction shown in FIG. 2) in radial part 30 at a position that is higher than the lowest surface of the bottom 23 by a predetermined height (H) to control permeation of moisture into the lower case 21 and allow flow of the cooling air.

For example, the side wall 24 is formed in a dual-layer configuration of an outer wall 241 and an inner wall 242 that are distanced from each other. The air hole 27 is formed in radial part 30 and between the outer wall 241 and inner wall 242. The inner wall 242 has a height protruded from the bottom 23, and the height (H) of the air hole 27 is set by the height of the inner wall 242.

In the first exemplary embodiment, two air holes 27 are formed at the radial part 30 where the bottom 23 is connected to the side wall 24. An appropriate number of air holes can be formed depending on the flow amount of the cooling air (not shown).

As shown in FIG. 3, the rechargeable battery pack 100 according to the first exemplary embodiment includes a sheet 31 with at least one of ventilation, insulation, and buffering functions between the supporter 25 and the unit cells 10. For example, the sheet 31 is formed with an insulating tape or an adhesive sponge to flexibly respond to the curved concave groove of the supporter 25.

When the sheet 31 has the buffering characteristic, it can stably support each unit cell 10 on the supporter 25. When the sheet 31 has ventilation, it forms a cooling air path between the supporter 25 and the unit cell 10 to prevent deterioration of cooling performance of the unit cell 10 on the supporter 25. Also, when the sheet 31 has insulation, it can prevent the short circuit of the unit cells 10 and the protection circuit module 11 by moisture having permeated between the supporter 25 and the unit cell 10.

The lower case 21 includes a reinforcing rib 28 protruded inside from the bottom 23, and a drainage hole 29 corresponding to the reinforcing rib 28. The reinforcing rib 28 is formed between the supporter 25 and the side wall 24 so that it may relate to the drainage hole 29 (refer to FIG. 2). The reinforcing rib 28 can be formed on various positions in the bottom (not shown).

The drainage hole 29 is formed to ease the discharge of moisture having permeated into the case 20 and simultaneously the reinforcing rib 28 prevents entry of foreign substances. Further, the drainage hole 29 allows the cooling air to flow, together with the air hole 27. Since the permeated moisture is discharged, watertight performance for the unit cells 10 and the protection circuit module 11 is improved. The protection function for the unit cells 10 is improved by preventing the permeation of an external foreign substance.

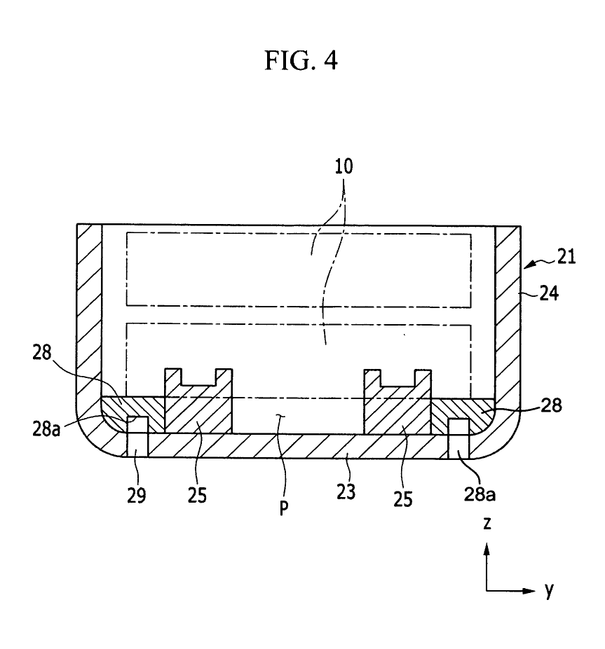

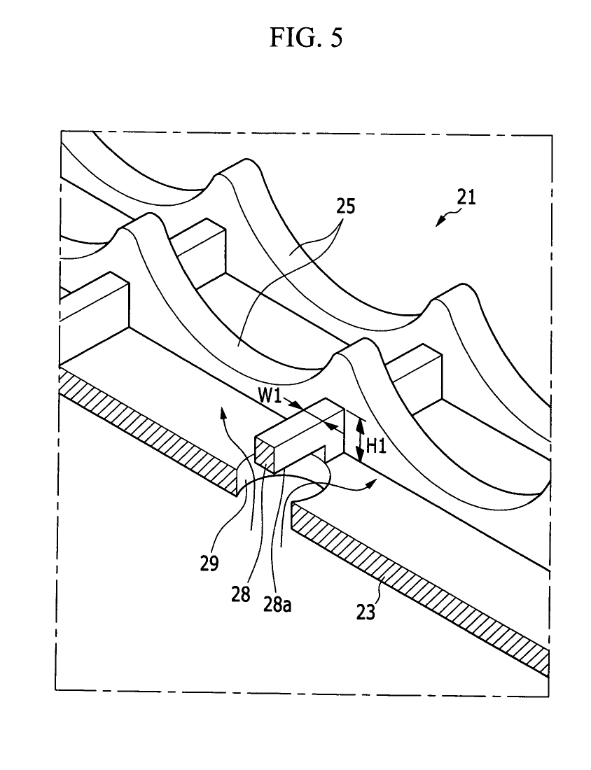

FIG. 4 shows a cross-sectional view with respect to a line IV-IV shown in FIG. 2, and FIG. 5 shows a partial cutaway perspective view of a drainage hole 29 shown in FIG. 4. Referring to FIG. 4 and FIG. 5, the drainage hole 29 discharges the internal moisture, and the reinforcing rib 28 provided in the drainage hole 29 prevents entry of a foreign object through the drainage hole 29. The reinforcing rib 28 provided in the drainage hole 29 prevents permeation of the foreign substance that may occur when the drainage hole 29 is formed in the bottom 23.

Also, the drainage hole 29 is further extended in the side direction of the reinforcing rib 28 and is formed in the bottom 23. For example, the reinforcing rib 28 has a height H1 and a width W1 that are set in the bottom 23 and is provided over the drainage hole 29. The drainage hole 29 is formed to have a diameter larger than the width W1 of the reinforcing rib 28 so a part of the drainage hole 29 is exposed outside the width W1 of the reinforcing rib 28 to drain water.

In addition to this, the reinforcing rib 28 includes a groove 28a connected to the drainage hole 29. That is, the groove 28a is formed to face the drainage hole 29 on the reinforcing rib 28. Accordingly, the drainage hole 29 passes through the bottom 23 to be connected to the side of the reinforcing rib 28 through the groove 28a. That is, the moisture having permeated into the case 20 flows on the bottom 23 to be discharged outside the lower case 21 after having passed through the groove 28a of the reinforcing rib 28 and the drainage hole 29.

The drainage hole 29 can be formed to have a circular cylinder shape extending from the inside of the bottom 23 to the outside thereof. The drainage hole 29 is formed corresponding to the reinforcing rib 28 of the bottom 23 so the reinforcing rib 28 and the drainage hole 29 can be formed in the lower case 21 by changing a part of a pattern for manufacturing the existing lower case. Therefore, the additional cost for forming the drainage hole 29 is minimized.

Various others exemplary embodiments will now be described, and the same configurations as in the first exemplary embodiment will not be described and different configurations from the first exemplary embodiment will be described.

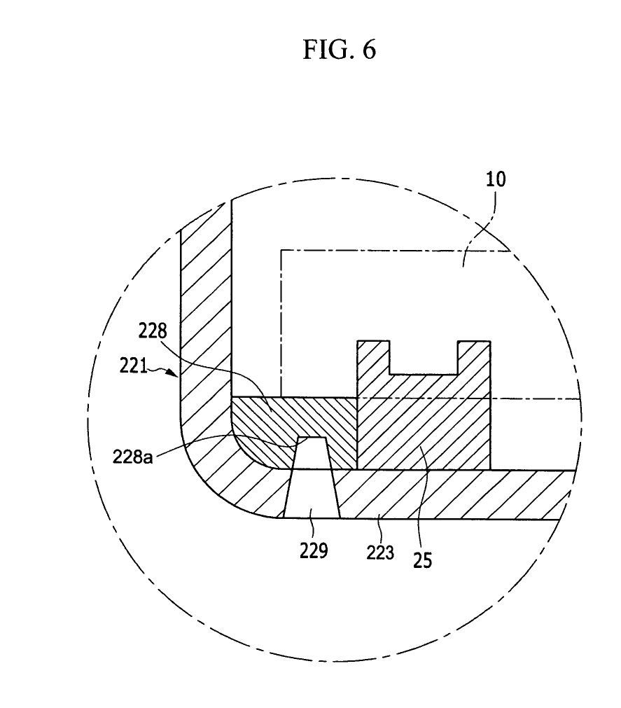

FIG. 6 shows a partial cross-sectional view of the lower case of a rechargeable battery pack according to a second exemplary embodiment. Referring to FIG. 6, a drainage hole 229 is formed to have a truncated circular cone shape extending from the inside of the bottom 223 to the outside thereof. A groove 228a of the reinforcing rib 228 corresponding to the drainage hole 229 is formed to have a truncated circular cone shape (or wedge shape) extending to a drainage hole 229 from the side that faces the drainage hole 229.

The truncated circular cone shape of the drainage hole 229 can further easily discharge the moisture having entered the lower case 221 compared to the circular cylinder shape of the drainage hole 29 described in the first exemplary embodiment. The drainage hole 229 can prevent intrusion of foreign substances by the side part of the truncated circular cone, and groove 228a also helps prevent intrusion of foreign substances.

The drainage hole 229 in the truncated circular cone shape and the groove 228a ease the separation process of the pattern when manufacturing the lower case 221 more than the drainage hole 29 in the circular cylinder shape and the groove 28a.

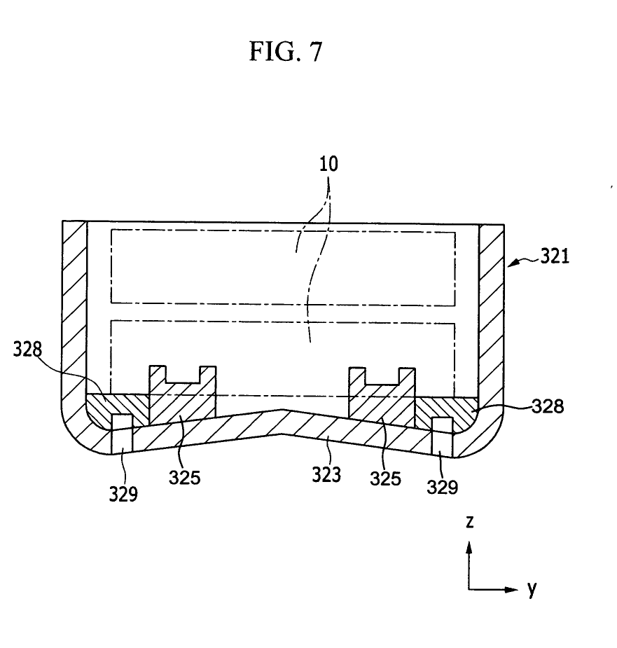

FIG. 7 shows a cross-sectional view of the lower case of a rechargeable battery pack according to a third exemplary embodiment. Referring to FIG. 7, a supporter 325 is formed on the bottom 323 corresponding to a side part of the unit cell 10 to support the side part of the unit cell 10. The bottom 323 may have a gradient so that the part where a drainage hole 329 corresponding to a reinforcing rib 328 may be lower than a central part of bottom 323.

The gradient of the bottom 323 can be formed in various manners. For example, the bottom 323 is formed to have a high center and a low outer portion. That is, the drainage hole 329 is formed on the low part of the bottom 323, that is, the outer portion of the bottom 323.

The bottom 323 of the rechargeable battery pack 300 according to the third exemplary embodiment increases the drainage through the drainage hole 329 by controlling the moisture having permeated into the lower case 321 to move to the outer portion by the gradient.

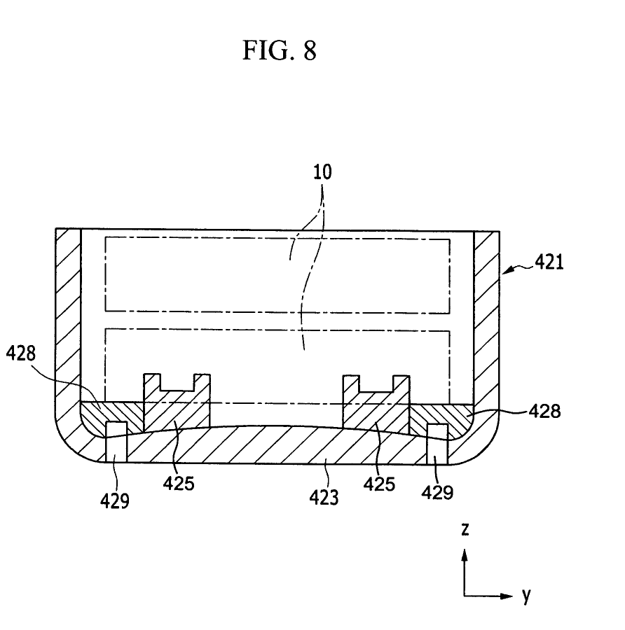

FIG. 8 shows a cross-sectional view of the lower case of a rechargeable battery pack according to a fourth exemplary embodiment. Referring to FIG. 8, a supporter 425 is formed on the bottom 423 corresponding to a side part of the unit cell 10 to support the side part of the unit cell 10. The bottom 423 is formed to have a thick center portion and a thin outer portion. A drainage hole 429 is formed on a low part of the bottom 423, that is, the outer portion of the bottom 423.

While the bottom 323 according to the third exemplary embodiment is formed with the same thickness to have a concave outer part, the bottom 423 according to the fourth exemplary embodiment is formed to have a flat outer portion and a convex inner center. The bottom 423 increases drainage by controlling the moisture having permeated into the lower case 421 to move to the outside drainage hole 429.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rechargeable battery pack comprising:
at least one unit cell including a rechargeable battery; and
a case for supporting the unit cell and receiving the same, the case including:
a bottom;
a reinforcing rib protruded from the bottom; and
a drainage hole formed in the bottom and beneath to the reinforcing rib, the reinforcing rib preventing penetration of a foreign object into the case.

2. The rechargeable battery pack of claim 1, the case further including:
a supporter formed on the bottom and corresponding to a side part of the unit cell so as to support the side part of the unit cell.

3. The rechargeable battery pack of claim 2, further including a ventilating sheet provided between the supporter and the unit cell.

4. The rechargeable battery pack of claim 2, further including an insulating sheet provided between the supporter and the unit cell.

5. The rechargeable battery pack of claim 2, further including a buffering sheet provided between the supporter and the unit cell.

6. The rechargeable battery pack of claim 1, the reinforcing rib including a groove disposed above the drainage hole.

7. The rechargeable battery pack of claim 1, the reinforcing rib having a height and a width, the reinforcing rib including a groove connected to the drainage hole to be disposed above the drainage hole, the drainage hole having a diameter larger than the width of the reinforcing rib.

8. The rechargeable battery pack of claim 1, the drainage hole having a circular cylinder shape or a truncated circular cone shape, extending from the inside of the bottom to the outside thereof.

9. The rechargeable battery pack of claim 1, the bottom having a gradient, the drainage hole being disposed in a portion of the bottom lower than a central portion of the bottom.

10. The rechargeable battery pack of claim 1, the drainage hole being disposed in an outer peripheral portion of the bottom, the bottom having a central portion higher than the outer peripheral portion.

11. The rechargeable battery pack of claim 1, the drainage hole being disposed in an outer peripheral portion of the bottom, the bottom having a central portion thicker than the outer peripheral portion.

12. The rechargeable battery pack of claim 1, the case further including:
an upper case and a lower case, the lower case having an outer wall and an inner wall, the lower case including a ventilation hole formed between the outer wall and inner wall at a height higher than a position of the drainage hole, the ventilation hole permitting air to enter the case to cool the unit cell, the air exiting the case through the drainage hole.

13. A rechargeable battery pack housing at least one unit cell including a rechargeable battery, the battery pack comprising:
an upper case;
a lower case, the lower case having a bottom;
a reinforcing rib protruded from the bottom; and
a drainage hole formed in the bottom and beneath the reinforcing rib, the reinforcing rib preventing penetration of a foreign object into the case.

14. The rechargeable battery pack of claim 13, the upper case receiving a protection circuit module and the lower case receiving the unit cell.

15. The rechargeable battery pack of claim 14, the lower case including a supporter formed on the bottom and corresponding to a side part of the unit cell so as to support the side part of the unit cell.

16. The rechargeable battery pack of claim 15, the reinforcing rib being disposed on an inner surface at an outer peripheral portion of the bottom between the supporter and a sidewall of the lower case.

17. The rechargeable battery pack of claim 16, the reinforcing rib including a groove disposed above the drainage hole.

18. The rechargeable battery pack of claim 15, further including a ventilating sheet provided between the supporter and the unit cell.

19. The rechargeable battery pack of claim 15, further including an insulating sheet provided between the supporter and the unit cell.

20. The rechargeable battery pack of claim 15, further including a buffering sheet provided between the supporter and the unit cell.
